(19) United States
(12) Patent Application Publication
(10) Pub. No.: US 2025/0180888 A1
(43) Pub. Date: Jun. 5, 2025

(54) METHOD FOR ALIGNING AND/OR POSITIONING A LASER MODULE OF A LASER PROJECTOR, LASER PROJECTOR, AND ALIGNING AND/OR POSITIONING DEVICE

(71) Applicant: Robert Bosch GmbH, Stuttgart (DE)

(72) Inventors: Christian Nitschke, Kusterdingen (DE); Johannes Fischer, Pliezhausen (DE)

(21) Appl. No.: 18/862,072

(22) PCT Filed: Jul. 14, 2023
(86) PCT No.: PCT/EP2023/069648

§ 371 Date: Oct. 31, 2024

(30) Foreign Application Priority Data
Oct. 20, 2022 (DE) 10 2022 211 102.8

(51) Int. Cl. G02B 26/08; G02B 26/10; G02B 27/01; H04N 9/31

(52) U.S. Cl. CPC G02B 26/0833; G02B 26/10; G02B 27/0172; H04N 9/3129; H04N 9/3161; G02B 2027/0178

(57) ABSTRACT

A method for aligning and/or positioning a laser module of a laser projector relative to at least one other laser module of the laser projector. A laser beam output by the laser module is scanned by a micromirror over a region which includes a target; Another laser beam output by the other laser module is scanned by the same micromirror over another region which includes the same target. A reflection signal of the scanned laser beam and another reflection signal of the other scanned laser beam are detected based on a micromirror operating parameter which is detected or ascertained simultaneously with the respective reflection signals. The alignment and/or position of at least the laser module is adapted.

### BACKGROUND INFORMATION

In some virtual retinal displays, it is necessary to introduce a plurality of laser sources that do not have the same optical paths into a laser projector. Various, sometimes relatively complex, methods for introducing and aligning laser modules in laser projectors for virtual retinal displays have already been proposed.

### SUMMARY

According to an example embodiment of the present invention, a method is provided for aligning and/or positioning a laser module of a laser projector, in particular a virtual retinal display (retinal scan display), relative to at least one other laser module of the laser projector, wherein, in at least one method step, a laser beam output by the laser module is scanned, in particular over the entire area, by a micromirror (MEM) over a region which comprises a target, wherein, in at least one method step, another laser beam output by the other laser module is scanned, in particular over the entire area, by the same micromirror over another region which comprises the same target, wherein, in at least one additional method step, a reflection signal, in particular reflected by the target, of the scanned laser beam and another reflection signal, in particular reflected by the target, of the other scanned laser beam are detected on the basis of micromirror operating parameters which are detected or ascertained simultaneously with the respective reflection signals, and wherein, in at least one additional method step, the alignment and/or position of at least the laser module is adapted relative to the at least one other laser module and/or the alignment and/or the position at least of the at least one other laser module is adapted relative to the laser module, in particular by manually or automatically displacing and/or rotating the laser modules relative to one another, until a reflection of the reflection signal of the laser beam by means of the target and a reflection of the other reflection signal of the other laser beam by means of the target are detected with an at least substantially matching operating parameter of the micromirror. By means of the method according to the present invention, a precise, robust, reliable and/or simple calibration of laser modules of a laser projector relative to one another can advantageously be achieved. Advantageously, by using the same MEM and the same target, all the laser modules of the laser projector, in particular all the wavelengths of the laser projector, can be aligned and calibrated relative to one another. In particular, a high level of robustness to different focal lengths, in particular of the individual laser modules, can advantageously be achieved, preferably in contrast to a camera-based approach. In addition, alignment and/or positioning can advantageously be made possible without the need for optics adapted to specific wavelengths. Furthermore, a size of a scanning region of the MEM can advantageously be changed as desired without having to adapt a device/sensor necessary for carrying out the method. Advantageously, no specific alignment of the device/sensor necessary for carrying out the method is necessary. Advantageously, the space required for the device necessary for carrying out the method can be kept comparatively small.

In particular, according to an example embodiment of the present invention, the laser projector is designed as a laser projector of the virtual retinal display, for example of data glasses. The virtual retinal display is in particular configured to scan an image content sequentially by deflecting at least one laser beam of at least one time-modulated light source, such as one or more laser diodes of a laser projector, and to project it directly onto the retina of the user's eye by means of optical elements. In particular, the laser projector is configured to generate image data and output them via a visible laser beam. In particular, the laser projector has colored (RGB) laser diodes that generate the visible laser beam for this purpose. Preferably, the colored (RGB) laser diodes form the laser module of the laser projector. It is also possible for each laser color to form its own laser module of the laser projector. In particular, the laser projector is configured to output an invisible laser beam. In particular, the laser projector unit has an infrared laser diode that generates the invisible laser beam, preferably the infrared laser beam. Preferably, the infrared laser diode forms the other laser module. Preferably, the infrared laser diode or the entire laser projector unit is designed as a ViP (VCSEL with integrated photodiode). In particular, the method is provided for aligning and/or positioning the infrared laser diode and the colored (RGB) laser diode with respect to one another. A micromirror, micro electromechanical mirror (MEM), is in particular an electromechanically operating mirror system consisting of one or more microscopically small movable mirrors that generate the scanned laser beams through movements. In particular, the MEM thereby spans an image area which is repeatedly scanned by the laser beam and the other laser beam. In particular, the MEM generates a projection of the laser beam and the other laser beam over the entire area. The different reflection signals can be detected simultaneously or in successive passes through the micromirror. For example, by alternately switching on the different laser modules and/or the different lasers of a laser module, each channel of the laser projector can be individually aligned relative to one another. In particular, the regions over which the micromirror scans the laser beams over the entire area are approximately the same size.

In particular, according to an example embodiment of the present invention, the device carrying out the method of the present invention comprises a control and/or regulating unit. A “control and/or regulating unit” is in particular to be understood as a unit with at least one electronic control unit. An “electronic control unit” is in particular to be understood as a unit with a processor and with a memory, and with an operating program stored in the memory. In particular, the control and/or regulating unit is provided at least for controlling the MEM. In particular, the control and/or regulating unit is provided at least for reading and/or detecting one or more operating parameters of the MEM. The operating parameter can be designed as a current angular position of the MEM, as a current movement position of the MEM or as a time signal of the MEM. “Provided” and/or “configured” is in particular to be understood as specifically programmed, designed, and/or equipped. The fact that an object is provided for a specific function is to be understood in particular to mean that the object fulfills and/or executes this specific function in at least one application and/or operating state.

If the operating parameter is a time signal of the micromirror or current position information of the micromirror, the operating parameter can advantageously be evaluated in a manner that is simple and/or not computationally intensive. In particular, in the additional method step in which the alignments and/or positions of the laser modules relative to one another are adjusted, at least two images of the target (e.g. an infrared image and a color image) are brought into registration, preferably by means of the information contained in the operating parameter.

According to an example embodiment of the present invention, it is further provided that at least the reflection signal and/or at least the other reflection signal is/are detected by at least one 1-D sensor, in particular by a photodiode. The method can thereby be kept advantageously simple. Aligning a 1-D sensor is advantageously much simpler than positioning a 2-D sensor such as a camera. Alternatively, 2-D sensors such as cameras would also be possible. Preferably, however, the sensor used in the method is different from a camera and in particular is structurally and/or technically simpler than a camera. In addition, cost-effective implementation can advantageously be achieved thereby. Advantageously, a high degree of independence from supply chain problems can be achieved, in particular since photodiodes are technically very simple and widely available components. It is possible for the 1-D sensor to be provided to measure all the wavelengths of all the laser modules simultaneously. In this case, the 1-D sensor would be designed as a broadband photodiode.

In addition, however, according to an example embodiment of the present invention, it is also provided for the reflection signal and the other reflection signal to be detected by different 1-D sensors, in particular by different, preferably narrow-band, photodiodes with different sensitivity spectra, for example a red photodiode, a green photodiode, a blue photodiode and an infrared photodiode. This advantageously makes it possible to achieve cost-effective implementation. Advantageously, a high level of accuracy can be achieved. Advantageously, the method can be carried out with continuously activated laser modules of the laser projector. Advantageously, there is no need to control the individual laser diodes/laser modules of the laser projector. Such narrow-band photodiodes could be obtained, for example, by using laser line filters, which each filter the light of the reflection signals transmitted to a sensor of the photodiode. Advantageously, a (small) spatial offset of the different 1-D sensors from one another has no influence on the feasibility or the result of the method according to the present invention.

If, as mentioned above, the reflection signal and the other reflection signal are detected by the same 1-D sensor, in particular by the same photodiode with a broad sensitivity spectrum, a particularly simple and/or cost-effective implementation for the device carrying out the method can advantageously be made possible. In particular, the sensitivity spectrum of the 1-D sensor in this case extends from infrared to visible blue light.

Furthermore, according to an example embodiment of the present invention, it is provided for the 1-D sensor(s), in particular photodiode(s), to be arranged (spatially) separately from and/or externally of the laser projector. This advantageously makes it possible to achieve a simple structure of the device necessary to carry out the method. Advantageously, a large number of laser projectors can be calibrated and/or aligned in a short time.

Preferably, the 1-D sensor is arranged at a distance from the laser projector.

According to an example embodiment of the present invention, it is also provided for the target to have an extended point shape, a line-like shape or a repeating pattern, such as a defined point cloud. This advantageously allows scaling and/or rotation alignment in addition to the areal alignment. An “extended point shape” is to be understood in particular as a pattern shape that comprises a large number of identical or different points, all of which have an areal extension. In particular, the points in a defined point cloud are provided with different point extensions, wherein preferably the respective relative size ratios and/or distance ratios of the individual points are known. In general, however, anything that reliably and preferably at least substantially identically reflects all the wavelengths emitted by the laser modules is suitable as a target.

If the target has an extension of at most 1 mm, preferably at most 0.5 mm, in at least one direction running perpendicularly to a (mean) propagation direction of the laser beam and/or the other laser beam, and in particular parallel to a scanning direction of the micromirror, a particularly high level of accuracy of the method of the present invention can advantageously be achieved. For example, the target can be designed as a reflective thread with a diameter of approximately 0.5 mm or less. In principle, however, larger targets with extensions of more than 1 mm, e.g. a model eye, are also possible. In particular, however, the target must be large enough to generate a sufficiently high reflection signal. Preferably, the extension of the target in the direction running perpendicularly to the propagation direction of the laser beam and/or the other laser beam, and in particular parallel to the scanning direction of the micromirror, is at least greater than 0.01 mm, preferably at least greater than 0.1 mm. In particular, the type of target also makes a difference, since, for example, a thread or a glass rod is simpler to align due to its corresponding rotational symmetry than a 2D plate, which could be tilted in a further axis. A spherical lens is also possible as a target.

If the laser beam and the other laser beam have different wavelengths, an alignment and/or positioning of different components of the laser projector relative to one another can be made possible. This ensures reliable functioning of the virtual retinal display and in particular of data glasses having the virtual retinal display.

Further provided according to an example embodiment of the present invention is at least a second other laser module, which outputs a second other laser beam and relative to which the laser module is aligned and/or positioned in a manner identical to the other laser module or which is aligned and/or positioned relative to the laser module and/or the other laser module in a manner identical to that in which the laser module and the other laser module were already aligned and/or positioned relative to one another. This allows an advantageous calibration of laser modules in laser projectors for virtual retinal displays to be achieved, in particular even if the colored laser diodes of the laser projector form different laser modules. In particular, the second other laser module emits a colored (visible) laser beam that has a different color (wavelength) from the colored (visible) light beam emitted by the other laser module. The second other laser module can also be combined with the other laser module in a common higher-level laser module. However, the laser module (infrared light) is preferably never combined with one of the other laser modules (visible light) in a higher-level laser module.

According to an example embodiment of the present invention, also provided is the laser projector having the laser module and having at least one of the other laser modules, wherein at least the laser module and at least one of the other laser modules are aligned and/or positioned relative to one another by means of the described method. This advantageously makes it possible to obtain a precise, robust and/or reliably calibrated laser projector.

The virtual retinal display, in particular in data glasses, having the laser projector is also provided according to an example embodiment of the present invention. This advantageously makes it possible to obtain high-quality data glasses that allow many applications. A pair of “data glasses” is in particular to be understood as a wearable device (head-mounted display) by means of which information can be added to the visual field of a user. Data glasses preferably allow for augmented reality and/or mixed reality applications. Data glasses are also commonly referred to as smart glasses. In particular, the data glasses have the virtual retinal display (also called retinal scan display or light field display), which is in particular familiar to the person skilled in the art.

In addition, according to an example embodiment of the present invention, an alignment and/or positioning device for carrying out the method of the present described above is provided, in particular having at least one first holding unit for positionally fixed mounting of the target, of the laser projector, of the 1-D sensor, preferably of the photodiode, and of the micromirror, and having at least one second holding unit for mounting of the laser module and at least the other laser module such that the position and/or alignment thereof can be modified. This can advantageously allow the method to carried out reliably and/or simply, in particular with a high throughput.

The method according to the present invention, the laser projector according to the present invention, the virtual retinal display according to the present invention, and the alignment and/or positioning device according to the present invention are not intended to be limited to the application and embodiment described above. In order to fulfill a functionality described herein, the method according to the present invention, the laser projector according to the present invention, the virtual retinal display according to the present invention, and the alignment and/or positioning device according to the present invention can in particular have a number of individual elements, components, units, and method steps that deviates from a number mentioned herein. In addition, in the case of the value ranges specified in this disclosure, values within the mentioned limits are also to be considered as disclosed and usable as desired.

### BRIEF DESCRIPTION OF THE DRAWINGS

Further advantages result from the following description of the figures. An embodiment of the present invention is illustrated in the figures. The disclosure herein contains numerous features in combination. A person skilled in the art will expediently also consider the features individually and combine them to form meaningful further combinations.

FIG. 1 shows a schematic representation of data glasses with a virtual retinal display having a laser projector, according toa example embodiment of the present invention.

FIG. 2 shows a schematic representation of an alignment and/or positioning device for carrying out an alignment and/or positioning method to be carried out before installing the laser projector in the data glasses, according to an example embodiment of the present invention.

FIG. 3 shows a schematic view of regions covered by scanning, over the entire area, of laser beams of individual uncalibrated laser modules of the laser projector by the micromirror, according to an example embodiment of the present invention.

FIG. 4 shows a reflection signal of a line-like target for the alignment and/or positioning method, according to an example embodiment of the present invention.

FIG. 5 shows a reflection signal of a target forming a defined point cloud for the alignment and/or positioning method, according to an example embodiment of the present invention.

FIG. 6 shows a schematic flow chart of the alignment and/or positioning method at least for aligning and/or positioning the laser module of the laser projector relative to the other laser module of the laser projector, according to an example embodiment of the present invention.

FIG. 7A shows a schematic view of signal-time diagrams of laser modules uncalibrated relative to one another, according to an example embodiment of the present invention.

FIG. 7B shows a schematic view of further signal-time diagrams of laser modules calibrated relative to one another by means of the alignment and/or positioning method, according to an example embodiment of the present invention.

### DETAILED DESCRIPTION OF EXAMPLE EMBODIMENTS

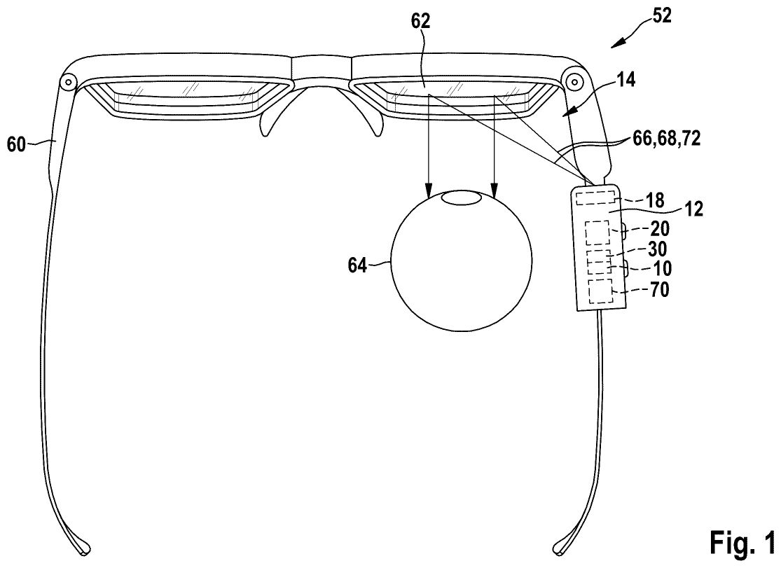

FIG. 1 shows a schematic representation of a pair of data glasses 52. The data glasses 52 have a virtual retinal display (retinal scanning display) 14. The data glasses 52 comprise an eyeglass frame 60. The data glasses 52 comprise eyeglass lenses 62. The virtual retinal display 14 is provided for displaying image data via a projection into an eye 64 of a user of the data glasses 52. The data glasses 52 have a laser projector 12. The virtual retinal display 14 has the laser projector 12. The laser projector 12 is designed as a scanned laser projector. The laser projector 12 is provided to generate and output scanned laser beams 66, 68, 72. One or more of the scanned laser beams 66, 72 generate an image display of the data glasses 52. Another scanned laser beam 68 can be provided for ascertaining a pupil position, pupil movement, pupil shape, and/or pupil size etc. The laser beams 66, 72 and the other laser beam 68 have different wavelengths. The visible scanned laser beams 66, 72 comprise a visible portion that is provided for outputting an image to the user's eye 64. The visible scanned laser beams 66, 72 are provided to output an image display directly onto a retina of the user's eye 64. The other scanned laser beam 68 comprises an infrared portion that is provided at least to ascertain the pupil position, pupil movement, pupil shape and/or pupil size of the user's eye 64. The image data are brought to the user's eye 64 by deflecting the laser beams 66, 68, 72 in the direction of the user's eye 64 by means of an optical element, such as a DOE or HOE, integrated in the spectacle lens 62. The general design of virtual retinal displays 14 and their integration into data glasses 52 is well-known to a person skilled in the art from their specialist knowledge.

The laser projector 12 is at least partially integrated into the eyeglass frame 60. The laser projector 12 has a laser module 10. The laser module 10 is provided to output the (visible) laser beam 66. The laser projector 12 has another laser module 20. The other laser module 20 is provided to output the (infrared) other laser beam 68. The laser module 10 and the other laser module 20 are separate from another. The other laser beam 68 is coupled into the already existing laser beam 66 in the laser projector 12. The laser projector 12 has a second other laser module 30. The laser module 10 and the second other laser module 30 could alternatively also be combined in a common module. The second other laser module 30 is provided to output a second other (visible) laser beam 72. The other laser beam 68 is coupled into the already existing second other laser beam 72 in the laser projector 12. Other additional laser modules are possible. The laser projector 12 has a micromirror (MEM) 18. The micromirror 18 is provided to scan the laser beams 66, 68, 72 over the entire area. The data glasses 52 have a control and/or regulating unit 70. Alternatively, the control and/or regulating unit 70 could also be separate from the data glasses 52 and have a communication link with the data glasses 52 (e.g. as a cloud or as an external smartphone, etc.). The control and/or regulating unit 70 is provided at least for controlling the laser projector 12. The control and/or regulating unit 70 is provided for executing an operating program of the data glasses 52, via which preferably at least most of the main functions of the data glasses 52 can be executed.

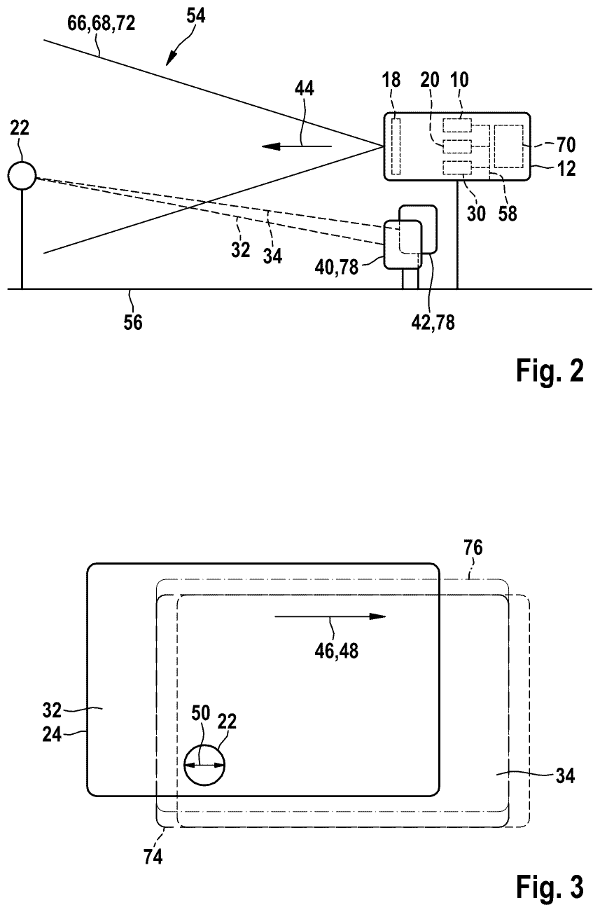

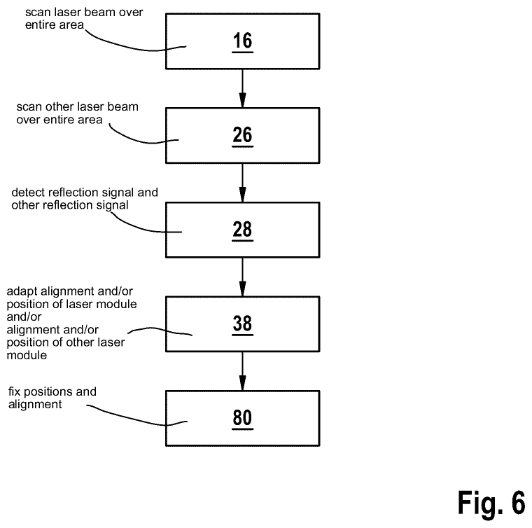

FIG. 2 schematically shows an alignment and/or positioning device 54 for carrying out a method (see also FIG. 6), in particular to be carried out before the installation of the laser projector 12 in the data glasses 52, for aligning and/or positioning the laser module 10 of the laser projector 12 and/or the second other laser module 30 of the laser projector 12 relative to the other laser module 20 of the laser projector 12. The alignment and/or positioning device 54 has a first holding unit 56. The first holding unit 56 is intended for positionally fixed mounting of a target 22 necessary for carrying out the method, of the laser projector 12 (not yet installed in the data glasses 52), of a 1-D sensor 40, 42 necessary for carrying out the method, and of the micromirror 18. The alignment and/or positioning device 54 has a second holding unit 58. The second holding unit 58 is provided for mounting the laser module 10 and at least the other laser module 20 and/or the second other laser module 30 such that the position and/or alignment thereof can be modified. The laser beams 66, 68, 72 have a mean propagation direction 44.

The alignment and/or positioning device 54 has optical sensors 78 that are provided to detect reflection signals 32, 34 of different laser beams 66, 68, 72. The optical sensors 78 are designed as 1-D sensors 40, 42. The 1-D sensors 40, 42 are designed as photodiodes. The 1-D sensors 40, 42 are arranged separately from the laser projector 12. The 1-D sensors 40, 42 are arranged externally of the laser projector 12. In the example shown, the different reflection signals 32, 34 are detected by different, in particular wavelength-adapted, 1-D sensors 40, 42. In this case, the 1-D sensors 40, 42 are designed as photodiodes with different sensitivity spectra.

However, it is also possible for the different reflection signals 32, 34 to be detected by a single 1-D sensor 40. In this, the 1-D sensor 40 is designed as a photodiode with a broad sensitivity spectrum.

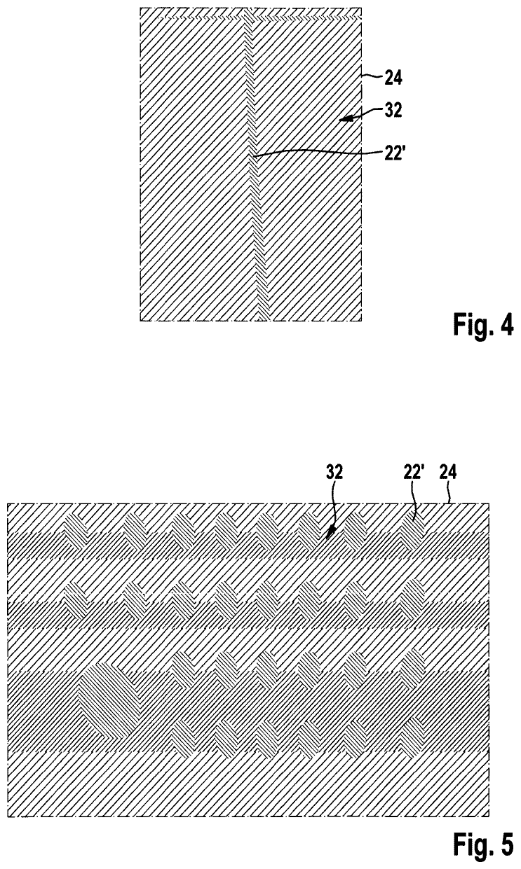

FIG. 3 schematically shows regions 24, 74, 76 that are covered by the scanning, over the entire area, of the laser beams 66, 68, 72 (uncalibrated laser modules 10, 20, 30) by the micromirror 18. The laser beam 66 emitted by the laser module 10 is scanned over the first region 24. The other laser beam 68 emitted by the other laser module 20 is scanned over the second region 74. The second other laser beam 68 emitted by the second other laser module 30 is scanned over the third region 76. The other region indicated in FIG. 3 can come from a third visible laser beam of an RGB projection system. The micromirror 18 has a scanning direction 46. The target 22 has an extension 50 of at most 1 mm in a direction 48 running perpendicularly to the propagation direction 44 of the laser beams 66, 68, 72 and parallel to the scanning direction 46 of the micromirror 18. The target 22 can have different shapes. In FIG. 3, the target 22 is shown by way of example in a round/extended point shape. In FIG. 4, a target 22′ is shown by way of example as a linearly extended/line-like shape. In the example of FIG. 4, the target 22′ is formed by a thin thread. In FIG. 5, a target 22″ is designed as a repeating pattern/as a defined point cloud.

FIG. 6 schematically shows a flow chart of the method for aligning and/or positioning the laser module 10 of the laser projector 12 relative to at least the other laser module 20 of the laser projector 12. It is noted that the laser module 10 can be aligned and/or positioned relative to the second other laser module 30 or to any other laser module of the laser projector 12 in a manner identical to the other laser module 20 or vice versa. It is also noted that the laser modules 10, 20, 30 of the laser projector 12 of the virtual retinal display 14 shown in FIG. 1 are also aligned and/or positioned relative to one another by means of the method described below.

In at least one method step 16, the laser beam 66 output by the laser module 10 is scanned, over the entire area, by the micromirror 18 over the region 24 comprising the target 22. In at least one additional method step 26, the other laser beam 68 output by the other laser module 20 is scanned, over the entire area, by the same micromirror 18 over the other region 74 comprising the same target 22. In at least one additional method step 28, the reflection signal 32 of the scanned laser beam 66 and the other reflection signal 34 of the other scanned laser beam 68 are detected on the basis of an operating parameter 36 of the micromirror 18 (cf. FIG. 6), which is detected or ascertained simultaneously with the respective reflection signals 32, 34. In at least one additional method step 38, the alignment and/or position of at least the laser module 10 is adapted relative to the other laser module 20 and/or the alignment and/or the position at least of the other laser module 20 is adapted relative to the laser module 10 until a reflection of the reflection signal 32 of the laser beam 66 by means of the target 22 and a reflection of the other reflection signal 34 of the other laser beam 68 by means of the same target 22 are detected with an at least substantially matching operating parameter 36 of the micromirror 18. In at least one additional method step 80, the positions and alignments of the laser modules 10, 20 thus set are fixed relative to one another. In this calibrated state with the fixed laser modules 10, 20, the laser projector 12 can then be installed in the virtual retinal display 14, preferably in the data glasses 52.

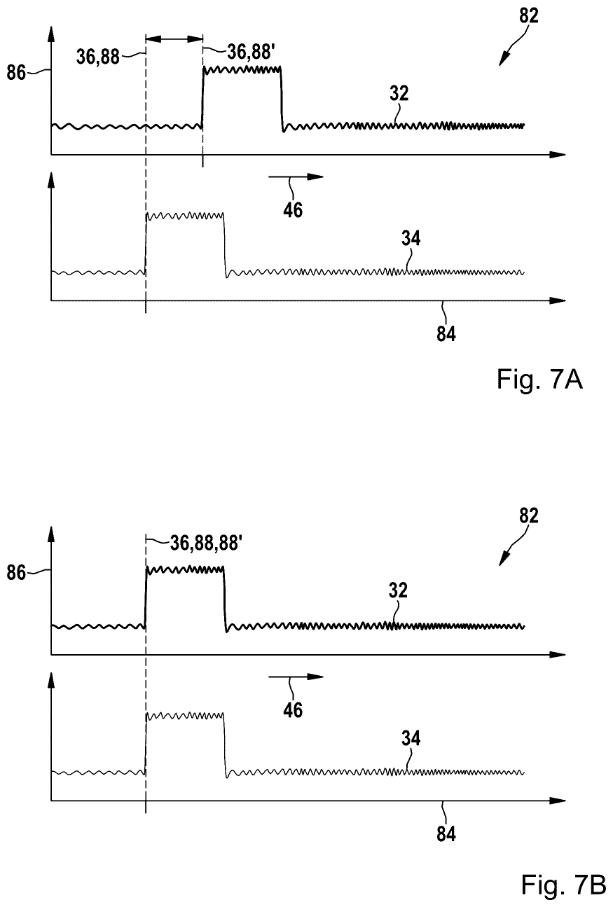

FIGS. 7A and 7B each schematically show the same extracts of a signal-time diagram 82, in which a time is plotted on an abscissa 84 and in which a signal of the optical sensor 78, in particular of the 1-D sensor 40/of the 1-D sensors 40, 42 in the two regions 24, 74 during a single passage through the respective regions 24, 74 by the scanned laser beams 66, 68 in the scanning direction 46 is plotted on an ordinate 86. The micromirror 18 has an operating parameter 36. The operating parameter 36 can be a time signal 88 of the micromirror 18 or current position information of the micromirror 18. In the case shown, the operating parameter 36 corresponds to the time signal 88, 88′ when the target 22 appears in the signal of the optical sensor 78, in particular the 1-D sensor 40/1-D sensors 40, 42 in the two regions 24, 74. FIG. 7A shows the still uncalibrated state of the laser modules 10, 20 relative to one another. The time signal 88 of the micromirror 18 associated with the laser module 10 is registered at a different location on the abscissa 84 than the time signal 88′ associated with the other laser module 20. The target 22 is thus scanned by the laser beams 66, 68 of the two laser modules 10, 20 at different locations in the scanned regions 24, 74 of the laser modules 10, 20. By shifting or pivoting the laser modules 10, 20 relative to one another, the time signals 88, 88′ are iteratively made to overlap. FIG. 7B shows the calibrated state of the laser modules 10, 20 relative to one another (at least in the scanning direction 46) after carrying out the method described above.

The proposed method makes use of the fact that a single 1-D sensor 40, 42, e.g. a single photodiode, only receives a single signal over time and does not create a spatial (two-dimensional) image like a camera. In order then to obtain a spatial signal again from the space-independent time signal 88, 88′ of the 1-D sensor 40, 42, the time signal 88, 88′ can be assigned to a current mirror position of the micromirror 18. In principle, however, this is not possible, and a superimposition of the time signals 88, 88′ is sufficient to align the laser modules 10, 20, in particular to make the regions 24, 74 overlap.

1-13. (canceled)

14. A method for aligning and/or positioning a laser module of a laser projector relative to at least one other laser module of the laser projector, the method comprising the following steps:
scanning a laser beam output by the laser module by a micromirror over a region that includes a target;
scanning another laser beam output by the other laser module by the same micromirror over another region which includes the same target;
detecting a reflection signal of the scanned laser beam and another reflection signal of the other scanned laser beam, based on an operating parameter of the micromirror which is detected or ascertained simultaneously with the respective reflection signal and other reflection signal; and
adapting the alignment and/or position of at least the laser module relative to the other laser module and/or adapting the alignment and/or position of the other laser module relative to the laser module, until a reflection of the reflection signal of the laser beam by the target and a reflection of the other reflection signal of the other laser beam by the target are detected with an at least substantially matching operating parameter of the micromirror.

15. The method according to claim 14, wherein the operating parameter is a time signal of the micromirror or current position information of the micromirror.

16. The method according to claim 14, wherein at least the reflection signal and/or at least the other reflection signal ise detected by at least one 1-D sensor including a photodiode.

17. The method according to claim 16, wherein the reflection signal and the other reflection signal are detected by different 1-D sensors including different photodiodes with different sensitivity spectra.

18. The method according to claim 16, wherein the reflection signal and the other reflection signal are detected by the same 1-D sensor including the same photodiode with a broad sensitivity spectrum.

19. The method according to claim 16, wherein the at least one 1-D sensor is arranged separately from and/or externally of the laser projector.

20. The method according to claim 14, wherein the target has an extended point shape or a line-like shape or a repeating pattern including a defined point cloud.

21. The method according to claim 14, wherein the target has an extension of at most 1 mm in at least one direction running perpendicularly to a propagation direction of the laser beam and/or the other laser beam, and parallel to a scanning direction of the micromirror.

22. The method according to claim 14, wherein the laser beam and the other laser beam have different wavelengths.

23. The method according to claim 14, wherein at least a second other laser module which outputs a second other laser beam and relative to which the laser module is aligned and/or positioned in a manner identical to the other laser module or which is aligned and/or positioned relative to the laser module and/or the other laser module in a manner identical to that in which the laser module and the other laser module were aligned and/or positioned relative to one another.

24. A laser projector, comprising:
at least one laser module; and
at least one other laser module, wherein at least the laser module and the other laser module are aligned and/or positioned relative to one another by:
scanning a laser beam output by the laser module by a micromirror over a region that includes a target,
scanning another laser beam output by the other laser module by the same micromirror over another region which includes the same target,
detecting a reflection signal of the scanned laser beam and another reflection signal of the other scanned laser beam, based on an operating parameter of the micromirror which is detected or ascertained simultaneously with the respective reflection signal and other reflection signal, and
adapting the alignment and/or position of at least the laser module relative to the other laser module and/or adapting the alignment and/or position of the other laser module relative to the laser module, until a reflection of the reflection signal of the laser beam by the target and a reflection of the other reflection signal of the other laser beam by the target are detected with an at least substantially matching operating parameter of the micromirror.

25. A virtual retinal display in data glasses, comprising:
a laser projector including:
at least one laser module, and
at least one other laser module, wherein at least the laser module and the other laser module are aligned and/or positioned relative to one another by:
scanning a laser beam output by the laser module by a micromirror over a region that includes a target,
scanning another laser beam output by the other laser module by the same micromirror over another region which includes the same target,
detecting a reflection signal of the scanned laser beam and another reflection signal of the other scanned laser beam, based on an operating parameter of the micromirror which is detected or ascertained simultaneously with the respective reflection signal and other reflection signal, and
adapting the alignment and/or position of at least the laser module relative to the other laser module and/or adapting the alignment and/or position of the other laser module relative to the laser module, until a reflection of the reflection signal of the laser beam by the target and a reflection of the other reflection signal of the other laser beam by the target are detected with an at least substantially matching operating parameter of the micromirror.

26. An alignment and/or positioning device, comprising:
at least one first holding unit configured for a positionally fixed mounting of a target, of a laser projector, of a 1-D sensor, and of a micromirror; and
at least one second holding unit configured to mounting a laser module and at least one other laser module such that the position and/or alignment thereof can be modified.
